(19) United States
(12) Patent Application Publication
(10) Pub. No.: US 2011/0159405 A1
(43) Pub. Date: Jun. 30, 2011

(54) Hydrophilic Polyelectrolyte Membranes Containing Poly(Vinyl Acetate) and Poly(Vinyl Alcohol)

(75) Inventors: Timothy J. Fuller, Pittsford, NY (US); Michael R. Schoeneweiss, W. Henrietta, NY (US); Sean M. MacKinnon, Fairport, NY (US); Frank Coms, Fairport, NY (US)

(73) Assignee: GM GLOBAL TECHNOLOGY OPERATIONS, INC., DETROIT, MI (US)

(21) Appl. No.: 12/650,019

(22) Filed: Dec. 30, 2009

(51) Int. Cl. H01M 8/10

(52) U.S. Cl. 429/492; 429/494

(57) ABSTRACT

An ion conducting membrane for fuel cell applications includes a combination of a polyvinyl polymer and an ion conducting polymer that is different than the polyvinyl polymer. The ion conducting membrane of this embodiment is able to operate in fuel cells at elevated temperatures with minimal external humidification. A fuel cell incorporating the ion conducting membrane between a first and second catalyst layer is also provided.

### TECHNICAL FIELD

The present invention relates to ion conducting membranes for fuel cell applications that can operate at high temperatures without external humidification.

### BACKGROUND

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”) to provide ion transport between the anode and cathode while also serving as an electrical insulator.

In proton exchange membrane type fuel cells, hydrogen is supplied to the anode as fuel, and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel to disperse over the surface of the membrane facing the fuel supply electrode. Each electrode has finely divided catalyst particles (for example, platinum particles), supported on carbon particles, to promote oxidation of hydrogen at the anode, and reduction of oxygen at the cathode. Protons flow from the anode through the ion conductive polymer membrane to the cathode where they combine with oxygen to form water which is discharged from the cell. Typically, the ion conductive polymer membrane includes a perfluorosulfonic acid (PFSA) ionomer.

The MEA is sandwiched between a pair of porous gas diffusion layers (“GDL”), which in turn are sandwiched between a pair of electrically conductive elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cells in stacks in order to provide high levels of electrical power. Although the present technologies associated with the ion conducting membranes work reasonably well, care must be taken to ensure that the membranes remain humidified. In particular, there is considerable interest in polyelectrolyte membranes for automotive fuel cell applications that can operate at elevated temperatures with minimal external humidification.

Accordingly, there is a need for improved ion conducting membranes that can operate at elevated temperatures with minimal external humidification

### SUMMARY OF EXEMPLARY EMBODIMENTS OF THE INVENTION

The present invention solves one or more problems of the prior art by providing in at least one embodiment an ion conducting membrane for fuel cell applications. The ion conducting membrane includes a combination of a polyvinyl polymer and an ion conducting polymer that is different than the polyvinyl polymer. Advantageously, the ion conducting membrane of this embodiment is able to operate in fuel cells at elevated temperatures (up to 120° C.) with minimal external humidification.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 is a schematic illustration of a fuel cell that incorporates a polymeric membrane of one or more embodiments of the invention;

FIG. 2 is a plot of cell voltage at 1.0 A/cm² current density under fully humidified conditions for a number of samples operated in a fuel cell (50 cm² hardware) under 2/2 H₂/air anode/cathode-stoichiometries, at 100/50% (anode/cathode) inlet relative humidity and 170 kPa gauge at 80° C.: Nafion® 1000 (DE2020) without an additive, with 10 wt. % polyvinyl acetate added, with 10 wt. % MnO₂ added, with 10 wt. % CeO₂ added, with 10 wt. % PtO₂ added, and with 10 wt. % RuO₂ added. The lifetime in the accelerated test is presented above the respective entries.

FIG. 3 is a plot of cell voltage at 1.0 A/cm² current density under dry operating conditions for a number of samples in a fuel cell (50 cm² hardware) under 2/2 H₂/air anode/cathode-stoichiometries, at 35/35% (anode/cathode) inlet relative humidity and 50 kPa gauge at 80° C.: Nafion® 1000 (DE2020) without an additive, with 10 wt. % polyvinyl acetate added, with 10 wt. % MnO₂ added, with 10 wt. % CeO₂ added, with 10 wt. % PtO₂ added, and with 10 wt. % RuO₂ added.

FIG. 4 is a table of the measured fluoride release rate with time in hours coming from the membrane under the accelerated test conditions.

### DETAILED DESCRIPTION OF EXEMPLARY EMBODIMENTS

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

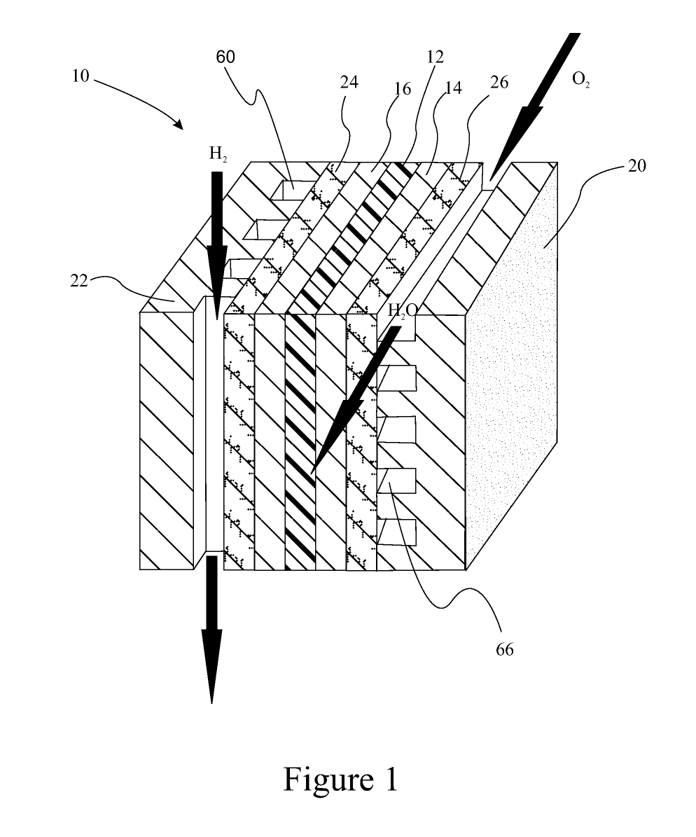

With reference to FIG. 1, a fuel cell that incorporates a polymer electrolyte including polymers from the invention is provided. PEM fuel cell 10 includes polymeric ion conductive membrane 12 disposed between cathode catalyst layer 14 and anode catalyst layer 16. Polymeric ion conductive composite membrane 12 includes one or more of the polymers set forth below. Fuel cell 10 also includes conductive plates 20, 22, gas channels 60 and 66, and gas diffusion layers 24 and 26. Advantageously, the present invention provides embodiments for composite membrane 12.

Ion conducting membrane 12 includes a combination of a first polymer that is a polyvinyl polymer and a second polymer that is different than the first polymer. In one refinement, the second polymer is an ion conducting polymer. In another refinement, this combination is a mixture. The ion conducting polymer includes a plurality of polymer segments having the following formula:

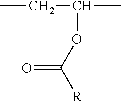

where R is an alkyl or aryl group. In particular, R is C₁₋₈ alkyl and C₆₋₁₅ aryl. In another refinement, R is a methyl, ethyl, propyl, or phenyl group. In a variation, the ion conducting polymer includes a plurality of positions at which the ester groups have been hydrolyzed as depicted in the following formulae:

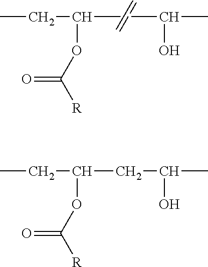

where R is as set forth above. The parallel lines intersecting the bond represent that a the ester groups and alcohol groups may be separated in the polymer backbone.

In a variation of the present embodiment, the polyvinyl polymer is present in an amount from about 0.1 to about 40 weight percent of the ion conducting membrane and the second polymer, that is different than the polyvinyl polymer is present in an amount from about 60 to about 99.9 weight percent of the ion conducting membrane. In another variation of the present embodiment, the polyvinyl polymer is present in an amount from about 5 to about 30 weight percent of the ion conducting membrane and the second polymer that is different than the polyvinyl polymer, is present in an amount from about 70 to about 95 weight percent of the ion conducting membrane. In still other variations, the ion conducting membrane includes one or more additional polymers (e.g., non-ionic polymers as set forth below). Preferably, in such situations, the polyvinyl polymer is present at about 5 to 10 weight of the admixture of polymers in the membrane with the balance being made up of the other polymers.

In one variation, the second polymer includes a cyclobutyl moiety and is an ion conducting polymer. Suitable polymers having cyclobutyl moieties are disclosed in U.S. Pat. Pub. No. 2007/0099054, U.S. patent application Ser. No. 12/197,530 filed Aug. 25, 2008; 12/197,537 filed Aug. 25, 2008; 12/197,545 filed Aug. 25, 2008; and 12/197,704 filed Aug. 25, 2008; the entire disclosures of which are hereby incorporated by reference. In a variation, the second polymer is an ion conducting polymer comprising polymer segment 1:

E₀-P₁-Q₁-P₂ 1

wherein:

Eₒ is a moiety having a protogenic group such as —SO₂X, —PO₃H₂, —COX, and the like;

P₁, P₂ are each independently: absent, —O—, —S—, —SO—, —CO—, —SO₂—, —NH—, NR₂—, or —R₃—;

R₂ is C₁₋₂₅ alkyl, C₁₋₂₅ aryl or C₁₋₂₅ arylene;

R₃ is C₁₋₂₅ alkylene, C₁₋₂₅ perfluoroalkylene, perfluoroalkyl ether, alkylether, or C₁₋₂₅ arylene;

X is an —OH, a halogen, an ester, or

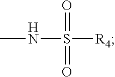

R₄ is trifluoromethyl, C₁₋₂₅ alkyl, C₁₋₂₅ perfluoroalkylene, C₁₋₂₅ aryl, or E₁ (see below); and

Q₁ is a fluorinated cyclobutyl moiety.

In variation of the present invention, the second polymer is an ion conducting polymer that comprises polymer segments 2 and 3:

[E₁(Z₁)_{d}]-P₁-Q₁-P₂ 2

E₂-P₃-Q₂-P₄ 3

Z₁ is a protogenic group such as —SO₂X, —PO₃H₂, —COX, and the like;

E₁ is an aromatic containing moiety;

E₂ is an unsulfonated aromatic-containing and/or aliphatic-containing moiety;

X is an —OH, a halogen, an ester, or

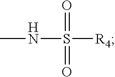

d is the number of Z₁ attached to E₁ (typically, d is 0, 1, 2, 3, or 4);

P₁, P₂, P₃, P₄ are each independently absent, —O—, —S—, —SO—, —CO—, —SO₂—, —NH—, NR₂—, or —R₃—;

R₂ is C₁₋₂₅ alkyl, C₁₋₂₅ aryl, or C₁₋₂₅ arylene;

R₃ is C₁₋₂₅ alkylene, C₁₋₂₅ perfluoroalkylene, perfluoroalkyl ether, alkylether, or C₁₋₂₅ arylene;

R₄ is trifluoromethyl, C₁₋₂₅ alkyl, C₁₋₂₅ perfluoroalkylene, C₁₋₂₅ aryl, or another E₁ group; and

Q₁, Q₂ are each independently a fluorinated cyclobutyl moiety.

In one refinement, d is equal to the number of aromatic rings in E₁. In another refinement, each aromatic ring in E₁ can have 0, 1, 2, 3, or 4 Z₁ groups.

In another variation of the present embodiment, the second polymer is an ion conducting polymer that:

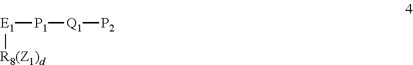

E₂-P₃-Q₂-P₄ 5

wherein:

Z₁ is a protogenic group such as —SO₂X, —PO₃H₂, —COX, and the like;

E₁, E₂ are each independently an aromatic-containing and/or aliphatic-containing moiety;

X is an —OH, a halogen, an ester, or

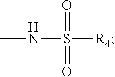

d is the number of Z₁ attached to R₈ (typically, d is 0, 1, 2, 3, or 4);

P₁, P₂, P₃, P₄ are each independently absent, —O—, —S—, —SO—, —CO—, —SO₂—, —NH—, NR₂—, or —R₃—;

R₂ is C₁₋₂₅ alkyl, C₁₋₂₅ aryl, or C₁₋₂₅ arylene;

R₃ is C₁₋₂₅ alkylene, C₁₋₂₅ perfluoroalkylene, perfluoroalkyl ether, alkylether, or C₁₋₂₅ arylene;

R₄ is trifluoromethyl, C₁₋₂₅ alkyl, C₁₋₂₅ perfluoroalkylene, C₁₋₂₅ aryl, or another E₁ group;

R₈(Z₁)_{d} is a moiety having d number of protogenic groups; and

Q₁, Q₂ are each independently a fluorinated cyclobutyl moiety.

In a refinement of this variation, R₈ is C₁₋₂₅ alkylene, C₁₋₂₅ perfluoroalkylene, perfluoroalkyl ether, alkylether, or C₁₋₂₅ arylene. In one refinement, d is equal to the number of aromatic rings in R₈. In another refinement, each aromatic ring in R₈ can have 0, 1, 2, 3, or 4 Z₁ groups. In still another refinement, d is an integer from 1 to 4 on average.

In another variation of the present embodiment, the second polymer is an ion conducting polymer that comprises segments 6 and 7:

E₁(SO₂X)_{d}—P₁-Q₁-P₂ 6

E₂-P₃-Q₂-P₄ 7

connected by a linking group L₁ to form polymer units 8 and 9:

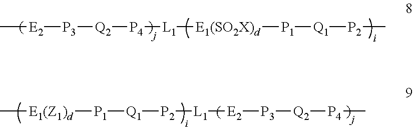

wherein:

Z₁ is a protogenic group such as —SO₂X, —PO₃H₂, —COX, and the like;

E₁ is an aromatic-containing moiety;

E₂ is an unsulfonated aromatic-containing and/or aliphatic-containing moiety;

L₁ is a linking group;

X is an —OH, a halogen, an ester, or

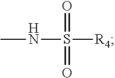

d is a number of Z₁ functional groups attached to E₁;

P₁, P₂, P₃, P₄ are each independently absent, —O—, —S—, —SO—, —SO₂—, —CO—, —NH—, NR₂—, —R₃—, and

R₂ is C₁₋₂₅ alkyl, C₁₋₂₅ aryl, or C₁₋₂₅ arylene;

R₃ is C₁₋₂₅ alkylene, C₁₋₂₅ perfluoroalkylene, or C₁₋₂₅ arylene;

R₄ is trifluoromethyl, C₁₋₂₅ alkyl, C₁₋₂₅ perfluoroalkylene, C₁₋₂₅ aryl, or another E₁ group;

Q₁, Q₂ are each independently a fluorinated cyclobutyl moiety;

i is a number representing the repetition of polymer segment 6 with i typically being from 1 to 200; and

j is a number representing the repetition of a polymer segment 7 with j typically being from 1 to 200. In one refinement, d is equal to the number of aromatic rings in E₁. In another refinement, each aromatic ring in E₁ can have 0, 1, 2, 3, or 4 Z₁ groups.

In still another variation of the present embodiment, the second polymer is an ion conducting polymer that comprises polymer segments 10 and 11:

E₁(Z₁)_{d}—P₁-Q₁-P₂ 10

E₂(Z₁)_{f}—P₃ 11

wherein:

Z₁ is a protogenic group such as —SO₂X, —PO₃H₂, —COX, and the like;

E₁, E₂ are each independently an aromatic or aliphatic-containing moiety wherein at least one of E₁ and E₂ includes an aromatic containing moiety substituted with Z₁;

X is an —OH, a halogen, an ester, or

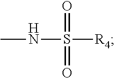

d is the number of Z₁ functional groups attached to E₁;

f is the number of Z₁ functional groups attached to E₂;

P₁, P₂, P₃ are each independently absent, —O—, —S—, —SO—, —SO₂—, —CO—, —NH—, NR₂—, or —R₃—;

R₂ is C₁₋₂₅ alkyl, C₁₋₂₅ aryl, or C₁₋₂₅ arylene;

R₃ is C₁₋₂₅ alkylene, C₁₋₂₅ perfluoroalkylene, perfluoroalkyl ether, alkyl ether, or C₁₋₂₅ arylene;

R₄ is trifluoromethyl, C₁₋₂₅ alkyl, C₁₋₂₅ perfluoroalkylene, C₁₋₂₅ aryl, or another E₁ group; and

Q₁ is a fluorinated cyclobutyl moiety,

with the proviso that when d is greater than zero, f is zero and when f is greater than zero, d is zero. In one refinement, d is equal to the number of aromatic rings in E₁. In another refinement, each aromatic ring in E₁ can have 0, 1, 2, 3, or 4 Z₁ groups. In still another refinement, d is an integer from 1 to 4 on average. In one refinement, f is equal to the number of aromatic rings in E₂. In another refinement, each aromatic ring in E₂ can have 0, 1, 2, 3, or 4 Z₁ groups. In still another refinement, f is an integer from 1 to 4 on average. In a variation, polymer segments 10 and 11 are each independently repeated 1 to 10,000 times to form respective polymer blocks that may be joined with a linking group L₁ shown below.

In still another variation of the present invention, the second polymer is an ion conducting polymer that includes polymer segment 12:

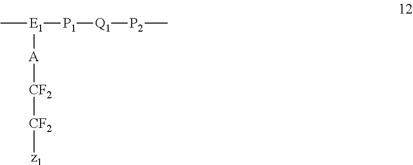

wherein:

Z₁ is a protogenic group such as —SO₂X, —PO₃H₂, or —COX, and the like;

E₁ is an aromatic containing moiety;

A is absent or O or a chain extender having a carbon backbone;

X is an —OH, a halogen, an ester, or

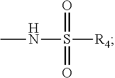

P₁, P₂ are each independently absent, —O—, —S—, —SO—, —SO₂—, —CO—, —NH—, NR₂—, or —R₃—;

R₂ is C₁₋₂₅ alkyl, C₁₋₂₅ aryl, or C₁₋₂₅ arylene;

R₃ is C₁₋₂₅ alkylene, C₁₋₂₅ perfluoroalkylene, or C₁₋₂₅ arylene;

R₄ is trifluoromethyl, C₁₋₂₅ alkyl, C₁₋₂₅ perfluoroalkylene, C₁₋₂₅ aryl, or another E₁ group; and

Q₁ is a fluorinated cyclobutyl moiety and in particular a perfluorocyclobutyl moiety.

In a refinement of this variation, A is an aromatic-containing moiety, an aliphatic-containing moiety, a polyether, a fluorinated polyether, and combinations thereof. In another refinement of the present embodiment, -ACF₂CF₂—Z₁ comprises a moiety having the following formula:

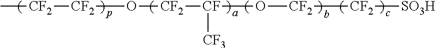

a, b, c, p are independently an integer from 1 to 10. In a refinement, p is 1, a is 0, b is 0, and c is 2. In another refinement, p is 0, a is 0, b is 0 and c is 2. In still another refinement, p is 1, a is 1, b is 0, and c is 2. In still another other refinement, p is 0, a is 0, b is 0, and c is 4. In yet another refinement, p is 0, a is 0, b is 0 and c is 1. In a variation, -ACF₂CF₂—Z₁ comprises:

—CF₂—CF₂—O—CF₂—CF₂—Z₁.

Examples for Q₁ and Q₂ in the above formulae are:

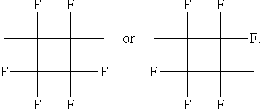

In each of the formulae 2-11, E₁ and E₂ include one or more aromatic rings. For example, E₁ and E₂, include one or more of the following moieties:

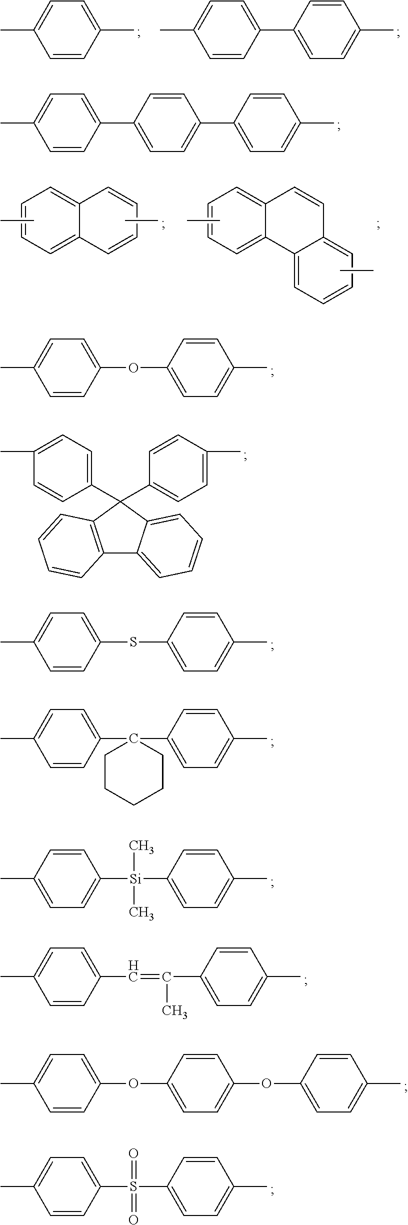

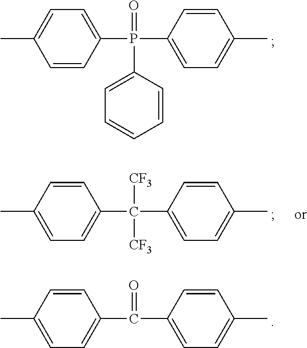

Examples of L₁ include the following linking groups

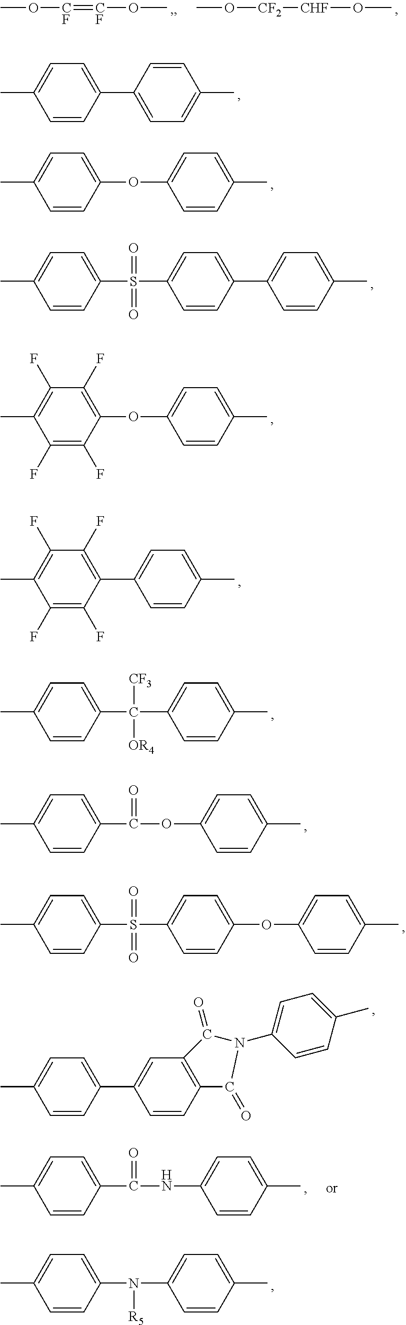

where R₅ is an organic group, such as an alkyl or acyl group.

In yet another variation of the present embodiment, the second polymer is an ion conducting polymer that is a perfluorosulfonic acid polymer (PFSA). In a refinement, such PFSAs are a copolymer containing a polymerization unit based on a perfluorovinyl compound represented by:

CF₂═CF—(OCF₂CFX¹)ₘ—Oᵣ—(CF₂)_{q}—SO₃H

where m represents an integer of from 0 to 3, q represents an integer of from 1 to 12, r represents 0 or 1, and X¹ represents a fluorine atom or a trifluoromethyl group and a polymerization unit based on tetrafluoroethylene. In one refinement, the ion conducting membrane includes a combination of PFSAs and perfluorocyclobutyl containing polymers and/or polymer segments as set forth above in formulae 1-12. In particular, a combination of PFSAs and perfluorocyclobutyl containing polymers with appended side groups as set forth in formula 12 is particularly useful.

In yet another variation of the present invention, the ion conducting membrane also includes a non-ionic polymer such as a fluoro-elastomer. The fluoro-elastomer may be any elastomeric material comprising fluorine atoms. The fluoro-elastomer may comprise a fluoropolymer having a glass transition temperature below about 25° C. or preferably, below 0° C. The fluoro-elastomer may exhibit an elongation at break in a tensile mode of at least 50% or preferably at least 100% at room temperature. The fluoro-elastomer is generally hydrophobic and substantially free of ionic groups. The fluoro-elastomer polymer chain may have favorable interaction with the hydrophobic domain of the second polymer described above. Such favorable interaction may facilitate formation of a stable, uniform and intimate blend of the two materials. The fluoro-elastomer may be prepared by polymerizing at least one fluoro-monomer such as vinylidene fluoride, tetrafluoroethylene, hexafluoropropylene, vinylfluoride, chlorotrifluoroethylene, perfluoromethylvinyl ether, and trifluoroethylene. The fluoro-elastomer may also be prepared by copolymerizing at least one fluoro-monomer and at least one non-fluoro-monomer such as ethylene, propylene, methyl methacrylate, ethyl acrylate, styrene, vinylchloride and the like. The fluoro-elastomer may be prepared by free radical polymerization or anionic polymerization in bulk, emulsion, suspension and solution. Examples of fluoro-elastomers include poly(tetrafluoroethlyene-co-ethylene), poly(vinyl id ene fluoride-co-hexafluoropropylene), poly(tetrafluoroethylene-co-propylene), terpolymer of vinylidene fluoride, hexafluoropropylene and tetrafluoroethylene, and terpolymer of ethylene, tetrafluoroethylene and perfluoromethylvinylether. Some of the fluoro-elastomers are commercially available from Arkema under trade name Kynar Flex® and Solvay Solexis® under the trade name Technoflon®, from 3M under the trade name Dyneon®, and from DuPont under the trade name Viton®. For example, Kynar Flex® 2751 is a copolymer of vinylidene fluoride and hexafluoropropylene with a melting temperature between about 130° C. and 140° C. The glass transition temperature of Kynar Flex® 2751 is about −40 to −44° C. The fluoro-elastomer may further comprise a curing agent to allow crosslinking reaction after being blended with the second polymer. In a refinement, the fluoro-elastomer is present in an amount from about in an amount from about 0.1 to about 40 weight percent of the ion conducting membrane.

In a particularly useful variation, the ion conducting membrane includes a combination of polyvinyl polymers, non-ionic polymers (e.g., Kynar), PFSAs, perfluorocyclobutyl containing polymers (or polymer segments) as set forth above in formulae 1-12. In a further refinement, the ion conducting membrane is a combination of polyvinyl polymers, non-ionic polymers (e.g., Kynar), PFSAs, perfluorocyclobutyl containing polymers set forth in formula 12.

In another variation of the present invention, the ion conducting membrane further includes an additive to improve stability. Examples of such additives include, but are not limited to, metal oxides. Examples of useful metal oxides include, but are not limited to, MnO₂, CeO₂, PtO₂, and RuO₂. Additional useful metal oxides are provided in U.S. Pat. Application No. 2008/0166620 filed Jul. 10, 2008, the entire disclosure of which is hereby incorporated by reference.

### EXPERIMENTAL

Polyvinyl acetate is added at 10 wt. % solids to Nafion® 1000 (DE2020) solution and the resultant solution was cast as a film onto a glass plate. After heating at 120° C. for at least 4 hours, the membrane is floated off the glass with deionized water and the free standing membrane film is allowed to air dry. The resultant, 25-micron membraneis built into a fuel cell with catalyst coated diffusion media and operates under an accelerated test protocol at Hydrogenics in Canada. The test consists of a 50 cm2 fuel cell build with catalyst-coated carbon-fiber diffusion media [Pt/C/perfluorosulfonic acid (PFSA) electrodes on carbon fiber diffusion media (SGL)] with alternating 5-minute cycles at 0.2 A/cm² and 10/10-anode/cathode H₂/air stoichiometries and 5-minute cycles at 0.8 A/cm² and 1.7/1.7 H₂/air stoichiometries and 50/50% inlet relative humidity at 80° C. and 75 kPa gauge. The physical cross-over leak must remain less than 10 standard cubic centimeters (sccms), otherwise a failure results. After 1492 hours of operation, the cell continued running without gas cross-over and is pin-hole free. Without the poly(vinyl acetate), a Nafion 1000 membrane prepared in the same way ran for 392 hours before developing a significant cross-over leak from a pin-hole.

### Fuel Cell Test Results

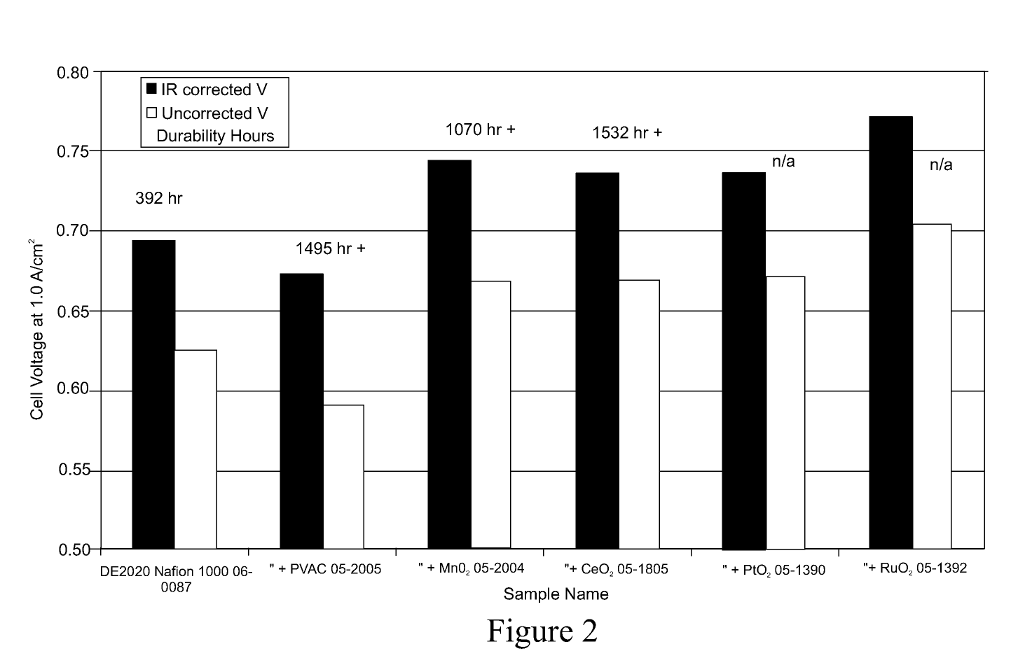

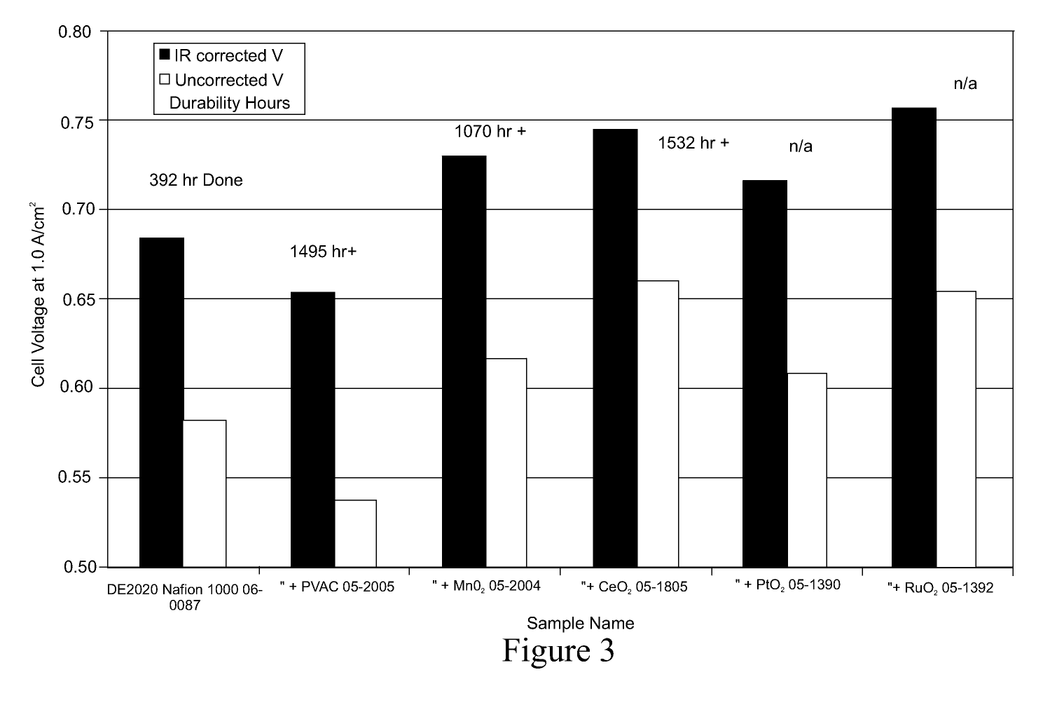

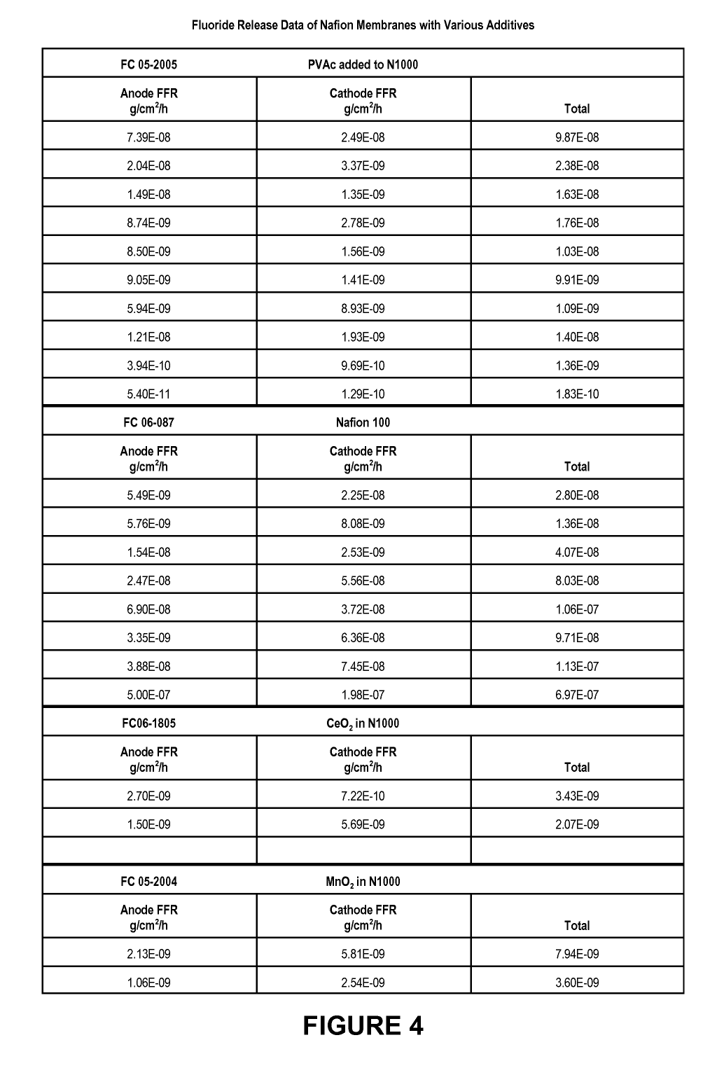

Because the polyvinyl acetate is not a proton conductor, there is a performance hit caused by adding this material. Nafion 1000 with 10 wt. % additive should result in a membrane with ion-exchange capacity approaching that of Nafion® 1100. Results are presented in the bar graphs of FIGS. 2 and 3. Fluoride release data are also presented in FIG. 4. FIG. 2 is a plot of cell voltage at 1.0 A/cm² current density under fully humidified conditions for a number of samples operated in a fuel cell (50 cm² hardware) under 2/2 H₂/air anode/cathode-stoichiometries, at 100/50% (anode/cathode) inlet relative humidity and 170 kPa gauge at 80° C.: Nafion® 1000 (DE2020) without an additive, with 10 wt. % polyvinyl acetate added, with 10 wt. % MnO₂ added, with 10 wt. % CeO₂ added, with 10 wt. % PtO₂ added, and with 10 wt. % RuO₂ added. The various metal oxides are added to prevent chemical degradation of the Nafion® 1000 membrane. The lifetime in the accelerated test is presented above the respective entries. For Nafion 1000 alone, the lifetime is 392 hours. For the poly(vinyl acetate) (PVAc) additive, the lifetime is greater than 1495 hours. For the MnO₂ and CeO₂ additives, the lifetimes are greater than 1070 and 1532 hours, respectively. The lifetimes are unavailable for PtO₂ and RuO₂. The PVAc profoundly helps the fuel cell life at a cost of less than 25 mV of cell voltage. FIG. 3 is a plot of cell voltage at 1.0 A/cm² current density under dry operating conditions for a number of samples in a fuel cell (50 cm² hardware) under 2/2 H₂/air anode/cathode-stoichiometries, at 35/35% (anode/cathode) inlet relative humidity and 50 kPa gauge at 80° C.: Nafion® 1000 (DE2020) without an additive, with 10 wt. % polyvinyl acetate added, with 10 wt. % MnO₂ added, with 10 wt. % CeO₂ added, with 10 wt. % PtO₂ added, and with 10 wt. % RuO₂ added. The PVAc profoundly helps the fuel cell life at a cost of less than 30 mV of cell voltage under these dry conditions. FIG. 4 is a table of the measured fluoride release rate with time in hours coming from the membrane under the accelerated test conditions. Fluoride emission from membrane is indicative of the amount of chemical degradation the membrane is undergoing in the fuel cell. For 10 wt. % poly(vinyl acetate) added to Nafion® 1000 membrane, the fluoride release rate was low (1.8×10⁻¹⁰ g/cm²/h), which compares to Nafion® 1000 without any additive (6.97×10⁻⁷ g/cm²/h), to Nafion® 1000 with 10 wt. % CeO₂ (2.07×10⁻⁹ g/cm²/h), and to Nafion® 1000 with 10 wt. % MnO₂ (3.60×10⁻⁹ g/cm²/h). Poly(vinyl acetate) is expected to hydrolyze to poly(vinyl alcohol) under fuel cell conditions. Moreover, poly(vinyl acetate) (PVAc)/poly(vinyl alcohol) (PVA) is expected to help disperse metal oxides such as the ones used here to help prevent the chemical degradation of polyelectrolyte fuel cell membranes. Therefore, combinations of metal oxides with PVAc/PVA are also expected to prevent membrane degradation in fuel cells.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A fuel cell comprising:
a first catalyst layer;
a second catalyst layer;
an ion conducting membrane interposed between the first and second catalyst layers, the ion conducting layer comprising:
a polyvinyl polymer;
an ion conducting polymer that is different than the polyvinyl polymer; and
a set of electrically conducting flow field plates in communication with the first and second catalyst layers.

2. The fuel cell of claim 1 wherein the polyvinyl polymer comprises a polyvinyl ester.

3. The fuel cell of claim 1 wherein the polyvinyl ester includes a plurality of moieties having the following formula: 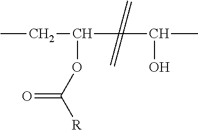
wherein R is an alkyl or aryl group.

4. The fuel cell of claim 1 wherein the polyvinyl ester comprises polyvinyl acetate.

5. The fuel cell of claim 1 wherein the ion conducting polymer comprises a plurality of protogenic groups.

6. The fuel cell of claim 5 wherein the protogenic groups include a component selected from the group consisting of —SO₂X, —PO₃H₂, and —COX,
X is an —OH, a halogen, an ester, or 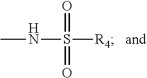
R₄ is trifluoromethyl, C₁₋₂₅ alkyl, C₁₋₂₅ perfluoroalkylene, or C₁₋₂₅ aryl.

7. The fuel cell of claim 1 wherein the ion conducting polymer comprises a PFSA polymer.

8. The fuel cell of claim 1 wherein the ion conducting polymer comprises a perfluorocyclobutyl group.

9. The fuel cell of claim 1 wherein the ion conducting polymer comprises a polymer described by formula 1:
E₀-P₁-Q₁-P₂ 1
wherein:
Eₒ is a moiety having a protogenic group such as —SO₂X, —PO₃H₂, —COX, and the like;
P₁, P₂ are each independently: absent, —O—, —S—, —SO—, —CO—, —SO₂—, —NH—, NR₂—, or —R₃—;
R₂ is C₁₋₂₅ alkyl, C₁₋₂₅ aryl or C₁₋₂₅ arylene;
R₃ is C₁₋₂₅ alkylene, C₁₋₂₅ perfluoroalkylene, perfluoroalkyl ether, alkylether, or C₁₋₂₅ arylene;
X is an —OH, a halogen, an ester, or 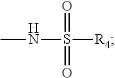
R₄ is trifluoromethyl, C₁₋₂₅ alkyl, C₁₋₂₅ perfluoroalkylene, C₁₋₂₅ aryl, or E₁ (see below); and
Q₁ is a fluorinated cyclobutyl moiety.

10. The fuel cell of claim 1 wherein the ion conducting polymer includes polymer segment 12: 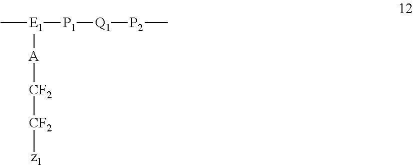
wherein:
Z₁ is a protogenic group such as —SO₂X, —PO₃H₂, or —COX, and the like;
E₁ is an aromatic containing moiety;
A is absent or O or a chain extender having a carbon backbone;
X is an —OH, a halogen, an ester, or 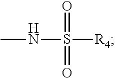
P₁, P₂ are each independently absent, —O—, —S—, —SO—, —SO₂—, —CO—, —NH—, NR₂—, or —R₃—;
R₂ is C₁₋₂₅ alkyl, C₁₋₂₅ aryl, or C₁₋₂₅ arylene;
R₃ is C₁₋₂₅ alkylene, C₁₋₂₅ perfluoroalkylene, or C₁₋₂₅ arylene;
R₄ is trifluoromethyl, C₁₋₂₅ alkyl, C₁₋₂₅ perfluoroalkylene, C₁₋₂₅ aryl, or another E₁ group; and
Q₁ is a fluorinated cyclobutyl moiety and in particular a perfluorocyclobutyl moiety.

11. The fuel cell of claim 1 wherein the ion conducting polymer comprises a PFSA polymer.

12. The fuel cell of claim 1 further comprising a non-ionic polymer.

13. The fuel cell of claim 12 wherein the non-ionic polymer is a fluoro-elastomer.

14. The fuel cell of claim 1 wherein the ion conducting polymer is a copolymer containing a polymerization unit based on a perfluorovinyl compound represented by:
CF₂═CF—(OCF₂CFX¹)ₘ—Oᵣ—(CF₂)_{q}—SO₃H
where m represents an integer of from 0 to 3, q represents an integer of from 1 to 12, r represents 0 or 1, and X¹ represents a fluorine atom or a trifluoromethyl group and a polymerization unit based on tetrafluoroethylene.

15. The fuel cell of claim 1 wherein the polyvinyl polymer is present in an amount from about 0.1 to about 40 weight percent of the ion conducting membrane and the ion conducting polymer that is different than the polyvinyl polymer is present in an amount from about 60 to about 99.9 weight percent of the ion conducting membrane.

16. The fuel cell of claim 1 wherein the ion conducting membrane further comprises a metal oxide.

17. A fuel cell comprising:
a first catalyst layer;
a second catalyst layer;
an ion conducting membrane interposed between the first and second catalyst layers, the ion conducting layer comprising:
polyvinyl polymer including a plurality of polymer segments having the following formula: 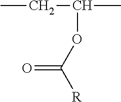
wherein R is an alkyl or aryl group. In particular, R is C₁₋₈ alkyl and C₆₋₁₅ aryl;
an ion conducting polymer that is different than the polyvinyl polymer; and
a set of electrically conducting flow field plates in communication with the first and second catalyst layers.

18. The fuel cell of claim 17 wherein the polyvinyl polymer includes a plurality of moieties having the following formula:

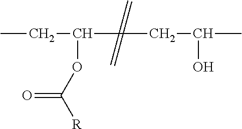

19. The fuel cell of claim 17 wherein the polyvinyl polymer comprises polyvinyl acetate.

20. The fuel cell of claim 17 wherein the ion conducting polymer comprises a plurality of protogenic groups.

21. The fuel cell of claim 20 wherein the protogenic groups include a component selected from the group consisting of —SO₂X, —PO₃H₂, and —COX,
X is an —OH, a halogen, an ester, or 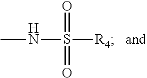
R₄ is trifluoromethyl, C₁₋₂₅ alkyl, C₁₋₂₅ perfluoroalkylene, or C₁₋₂₅ aryl. (and PFCBs with side chain PFSAs such as —(CF₂CF₂O)ₙCF₂CF₂SO₃H, where n=0, 1, 2, 3 etc. and blends with PFSAs and blends with Kynar.

22. The fuel cell of claim 17 wherein the ion conducting polymer comprises a PFSA polymer.

23. The fuel cell of claim 22 wherein the ion conducting polymer comprises a perfluorocyclobutyl group.

24. The fuel cell of claim 23 wherein the ion conducting polymer comprises a polymer described by formula 1:
E₀-P₁-Q₁-P₂ 1
wherein:
Eₒ is a moiety having a protogenic group such as —SO₂X, —PO₃H₂, —COX, and the like;
P₁, P₂ are each independently: absent, —O—, —S—, —SO—, —CO—, —SO₂—, —NH—, NR₂—, or —R₃—;
R₂ is C₁₋₂₅ alkyl, C₁₋₂₅ aryl or C₁₋₂₅ arylene;
R₃ is C₁₋₂₅ alkylene, C₁₋₂₅ perfluoroalkylene, perfluoroalkyl ether, alkylether, or C₁₋₂₅ arylene;
X is an —OH, a halogen, an ester, or 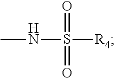
R₄ is trifluoromethyl, C₁₋₂₅ alkyl, C₁₋₂₅ perfluoroalkylene, C₁₋₂₅ aryl, or E₁ (see below); and
Q₁ is a fluorinated cyclobutyl moiety.

25. The fuel cell of claim 17 wherein the ion conducting polymer further comprises a metal oxide.
